(19) United States
(12) Patent Application Publication
(10) Pub. No.: US 2017/0337644 A1
(43) Pub. Date: Nov. 23, 2017

(54) DATA DRIVEN INVOCATION OF REALTIME WIND MARKET FORECASTING ANALYTICS

(71) Applicant: General Electric Company, Schenectady, NY (US)

(72) Inventors: Nandakumar IYENGAR, San Ramon, CA (US); Leonides Rodil DE OCAMPO, San Ramon, CA (US)

(21) Appl. No.: 15/161,458

(22) Filed: May 23, 2016

(51) Int. Cl. G06Q 50/06

(52) U.S. Cl. CPC G06Q 50/06

(57) ABSTRACT

According to some embodiments, system and methods are provided comprising receiving, at a distribution center module, one or more data elements; determining one or more analytic modules associated with the data element; transmitting the one or more data elements to the one or more analytic modules based upon receipt at the distribution center module of the one or more data elements; generating a forecast of energy production via the one or more analytic module; and operating an asset based on the forecast of energy production. Numerous other aspects are provided.

### BACKGROUND

Wind turbines are contributors to power generation to supply electrical grids. Generally, a wind turbine includes a turbine having multiple blades. The blades transform the wind energy into a mechanical rotational torque that drives one or more generators. The generator converts the rotational mechanical energy to electrical energy, which is fed into a utility grid via at least one electrical connection. Some power generation developers have wind farms having many (e.g., one hundred or more) wind turbine generators, making wind turbine generators an increasingly feasible source of power for the power grid

Often efficient power production in a wind farm makes use of data collected from the wind farm. Typically data is collected from sensors at regular intervals and transmitted to a central data repository. Different analytics then access the central data repository to retrieve the collected data and perform different analytics on the data. Some challenges with current data collection and analytic systems are trying to retrieve data as soon as it arrives, especially when data is arriving at a fast interval. The analytics may retrieve data at fixed intervals, but this does not guarantee that the analytics can get the data that has arrived. For example, if there is a delay in the data arriving to the central data repository, then the analytic may not retrieve it as soon as it arrives. In other cases data may arrive at irregular intervals, in which case a mechanism has to be built to notify the Analytics of the incoming data so that it can go and retrieve it. This may cause the analytic systems to wait for certain time intervals to pass when the analytic system can then retrieve the data. The time and resources used by different analytic systems to determine which data they need, whether the needed data is available and then when it is available, and to retrieve the needed data from the central data repository may be inefficient.

Therefore, it would be desirable to provide a system and method that more efficiently provides analytic systems with access to data provided by wind farms.

### BRIEF DESCRIPTION

According to some embodiments, a method includes receiving, at a distribution center module, one or more data elements; determining one or more analytic modules associated with the data element; transmitting the one or more data elements to the one or more analytic modules based upon receipt at the distribution center module of the one or more data elements; generating a forecast of energy production via the one or more analytic module; and operating an asset based on the forecast of energy production.

According to some embodiments, a system includes a distribution center module operative to receive one or more data elements; one or more analytic modules operative to generate a forecast of energy production based on data elements received from the distribution center module; a memory in communication with the distribution center module and storing program instructions, the distribution center module operative with the program instructions to perform the functions as follows: mapping the one or more received data elements to one or more analytic modules; and transmitting the one or more data elements to the one or more analytic modules based upon receipt of the one or more data elements and mapping of the one or more data elements; one or more decision modules operative to receive the forecast and execute operation of an asset based on the forecast of energy production.

A technical effect of some embodiments of the invention is an improved technique and system for providing data to analytic modules. In one or more embodiments, a benefit of the distribution center module pushing out the data is that the analytic modules do not have to poll for data. Another benefit of the distribution center module pushing out the data is that if the data arrives at irregular intervals, then this mechanism described in embodiments solves the problem of waiting for a certain time to retrieve the data by delivering the data to the analytic module as soon the data arrives. A benefit of embodiments is that by more efficiently providing data to analytic modules, forecasting or predicting an amount of energy produced by a wind farm, or a turbine at a wind farm, may be more efficient and timely. More efficient energy production forecasting may provide for more efficient and accurate interaction with the energy market. The inventors note that for typical wind farms, embodiments may result in about 35 GW/year or 1 M$/year cost-savings on top of existing market forecast tools. With this and other advantages and features that will become hereinafter apparent, a more complete understanding of the nature of the invention can be obtained by referring to the following detailed description and to the drawings appended hereto.

Other embodiments are associated with systems and/or computer-readable medium storing instructions to perform any of the methods described herein.

### DRAWINGS

FIG. 1 illustrates a system according to some embodiments.

FIG. 2 illustrates a flow diagram according to some embodiments.

FIG. 3 illustrates a block diagram of a system according to some embodiments.

FIG. 4 illustrates a table according to some embodiments.

### DETAILED DESCRIPTION

Wind turbines are contributors to power generation to supply electrical grids. Generally, a wind turbine includes a turbine having multiple blades. The blades transform the wind energy into a mechanical rotational torque that drives one or more generators. The generator converts the rotational mechanical energy to electrical energy, which is fed into a utility grid via at least one electrical connection. Some power generation developers have wind farms having many (e.g., one hundred or more) wind turbine generators, making wind turbine generators an increasingly feasible source of power for the power grid.

Often efficient power production in a wind farm makes use of data collected from the wind farm. Typically data is collected from sensors at regular intervals and transmitted to a central data repository. Different analytics then access the central data repository to retrieve the collected data and perform different analytics on the data. Some challenges with current data collection and analytic systems are trying to retrieve data as soon as it arrives, especially when data is arriving at a fast interval. The analytics may retrieve data at fixed intervals, but this does not guarantee that the analytics can get the data that has arrived. For example, if there is a delay in the data arriving to the central data repository, then the analytic may not retrieve it as soon as it arrives. In other cases data may arrive at irregular intervals, in which case a mechanism has to be built to notify the Analytics of the incoming data so that it can go and retrieve it. The time it takes for the analytic systems to wait for certain time intervals to pass when the analytic system can then retrieve the data, and the time and resources used by different analytic systems to determine which data they need, whether the needed data is available and then, when the needed data is available, to retrieve the needed data from the central data repository may be inefficient.

While examples used in descriptions of embodiments of the invention may be described with respect to one or more wind turbines or a wind farm, any suitable system that routes generated data to one or more analytic modules may be used.

Some embodiments provide a method and system for mapping, at a distribution center module, one or more data elements to one or more analytic modules, where the data elements are pushed (e.g., sent) to the appropriate analytic module at an appropriate time (e.g., based on a priority indicator, based on a timing mechanism, etc.), without the analytic module calling for the data. In some embodiments, the data elements may be pushed to the appropriate analytic module when the data elements arrive at the distribution center module per the mapping.

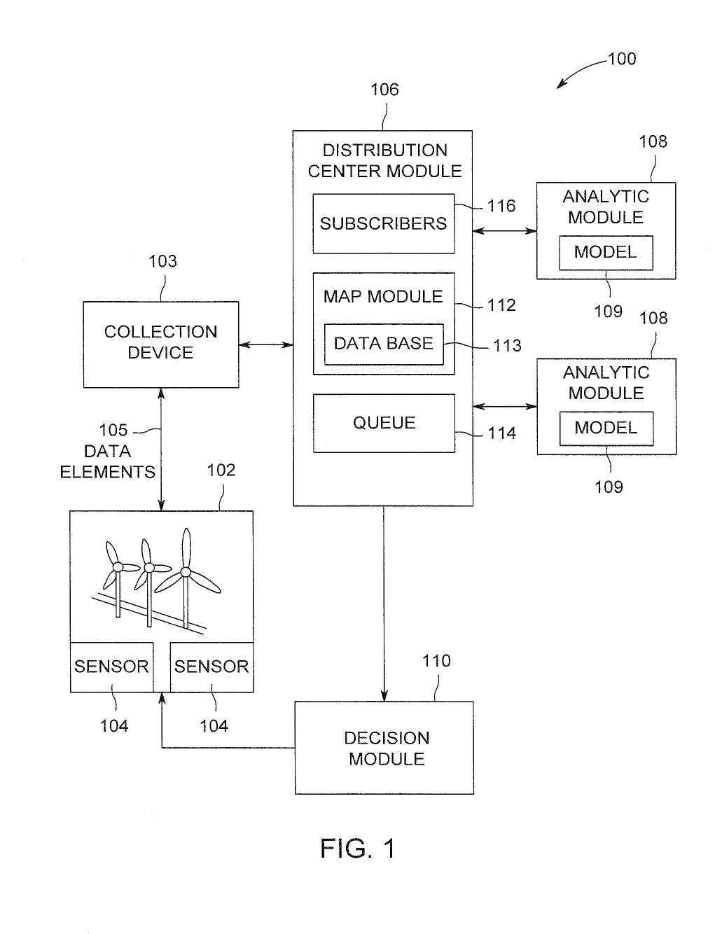

Turning to FIG. 1, a block diagram of a system 100 including an asset 102 according to some embodiments is provided. Although the system 100 includes one asset 102, the systems and method described herein may be applied to any system 100 containing any number of a variety of assets 102. While a wind turbine may be an example of the asset described herein, any suitable asset (e.g., traditional fossil fuel plants, nuclear power plants) that generates data that needs to be analyzed maybe used. As used herein, the terms “wind turbine,” “wind farm” and “asset” may be used interchangeably.

The asset 102 may include one or more sensors 104 to obtain data elements 105 from the asset 102. In some embodiments, the sensor 104 may be configured to obtain at least one kind of data element 105. For example, the sensor 104 may be configured to take temperature measurements, pressure measurements, humidity level measurements, or any other suitable measurements used for weather forecasting. In one or more embodiments, the sensors 104 may store the data elements 105 in a memory (not shown).

In one or more embodiments, the sensors 104 may transmit the data elements 105 to another device (e.g., a collection device (Edge device) 103, or a distribution center module 106), and the asset 102 may receive data and instructions. As conventionally known, “Edge” is a generic name for any device (e.g., computer node) that sits at the periphery of the control systems. In one or more embodiments, a tag may be associated with the data element 105. The tag may include information about the data element, for example, at least one of a name of the data element, a value of the data element and an attribute of the data element. Other suitable information may be included in the tag. The sensors 104 and asset 102 may use a variety of wireless communication protocols to transmit data elements 105 and receive data and instructions. In some embodiments, the collection device 103 may collect the data from all of the sensors 104 on all of the assets 102 in one or more wind farms. The collection device 103 may include software for communication with the distribution center module 106. While the system 100 shown in FIG. 1 includes a collection device 103, in some embodiments, the data elements 105 may be transmitted directly from the sensors 104 to the distribution center module 106.

The system 100 may also include a distribution center module 106, one or more analytic modules 108 and a decision module 110.

The distribution center module 106 may be a distributed router and may include a map module 112, a queue 114 and one or more subscribers 116.

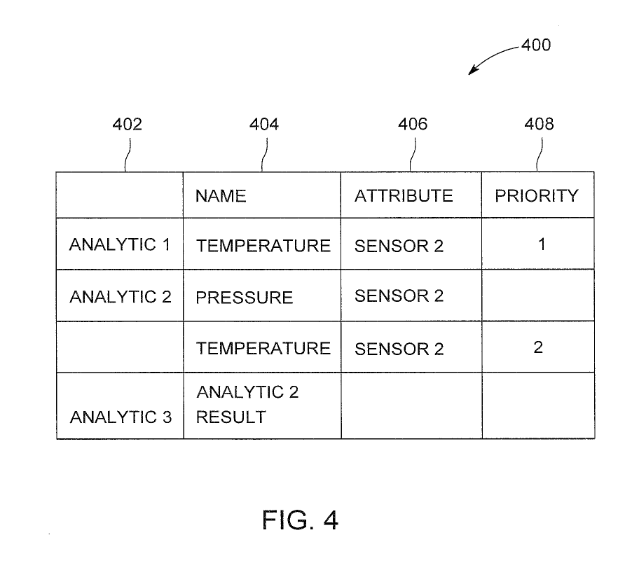

In some embodiments, the map module 112 may be operative to associate or map the data elements with a particular analytic module 108, as described further below. In some embodiments, after mapping, the data elements 105 may be associated with a priority indicator 408 (FIG. 4), as further described below.

In some embodiments, the map module 112 may store the data elements 105 and associated information (e.g., name, attribute, analytic module, calling mechanism) in a database 113 and one or more applications may use the database data model, with its tables, hierarchies, views and database procedures to map or associate the data elements 105 with an appropriate analytic module 108. Continuing with the wind turbine example, the database may store the name of the data element (e.g., temperature, pressure, humidity level), the value associated with the data element, attribute information (e.g., source, wind speed, wind direction, unit of measure) and any other suitable weather forecasting features.

Database 113 may comprise any query-responsive data source or sources that are or become known, including but not limited to a structured-query language (SQL) relational database management system. Database 113 may comprise a relational database, a multi-dimensional database, an eXtendable Markup Language (XML) document, or any other data storage system storing structured and/or unstructured data. The data of database 113 may be distributed among several relational databases, dimensional databases, and/or other data sources. Embodiments are not limited to any number or types of data sources

The elements of the system 100 (e.g., asset 102, collection device 103, distribution center module 106, analytic module 108 and decision module 110) may communicate through any suitable communication interface.

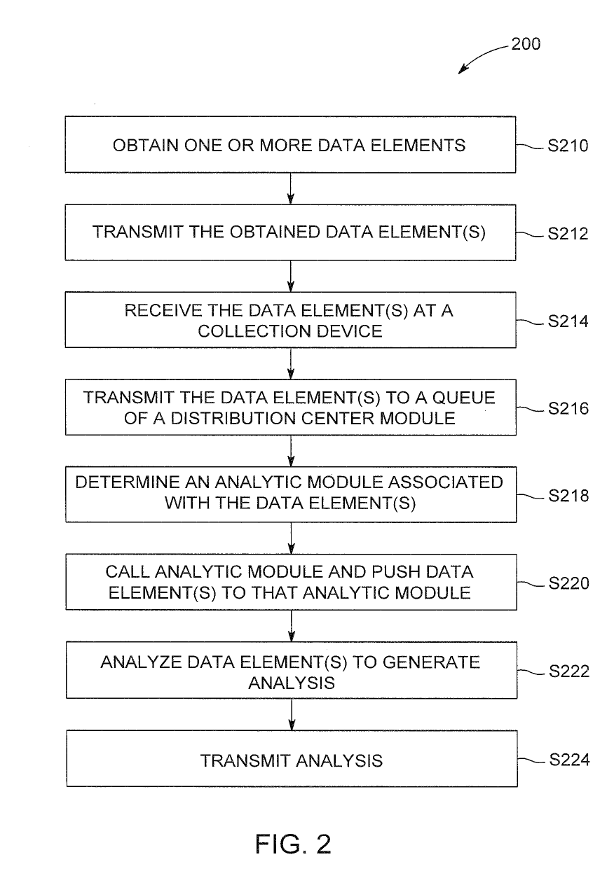

Turning to FIG. 2, an example of operation according to some embodiments is provided. In particular, FIG. 2 is a flow diagram of a process 200 according to some embodiments. Process 200 and other processes described herein may be performed using any suitable combination of hardware (e.g., circuit(s)), software or manual means. In one or more embodiments, the system 100 is conditioned to perform the process 200 such that the system is a special-purpose element configured to perform operations not performable by a general-purpose computer or device. Software embodying these processes may be stored by any non-transitory tangible medium including a fixed disk, a floppy disk, a CD, a DVD, a Flash drive, or a magnetic tape. Examples of these processes will be described below with respect to embodiments of the system, but embodiments are not limited thereto.

Initially, at S210, the sensor 104 obtains a measurement (e.g., “data element”) of the asset 102. The measurement may be obtained via conventional operation of the sensor 104. Then, in S212, the sensor transmits the obtained data element(s). In one or more embodiments, the obtained data element(s) is “raw” data in that it has not been analyzed or manipulated. In some embodiments the obtained data element is analyzed prior to transmission to the distribution center module 106, and it is the analyzed data element that is transmitted. In some embodiments, the data may be analyzed to determine the quality of the data and possibly cleanse the data to be more accurate prior to transmission to the distribution center module, as described further below. The obtained raw data element 105 is received at the collection device 103 in S214. In some embodiments, the data elements 105 received at the collection device 103 may be cleansed by the collection device 103 to provide a more accurate data element prior to further transmission.

Then in S216 the data element 105 is transmitted to the distribution center module 106 and received at the queue 114.

In some embodiments, the data element 105 is associated with one or more analytic modules 108 via the map module 112. As described above, the incoming data element 105 includes a name, a value and one or more attributes. In some embodiments, prior to performing process 200, the map module 112 uses names and attributes associated with the data elements to associate each possible data element with a particular analytic module 108 in a mapping database 113. In some embodiments, the association between the data element and a specific analytic module 108 may be referred to as the “Calling Mechanism.” For example, a data element 105 with a name “temp” and an attribute “sensor 2” may be associated with Analytic Module 1. In some embodiments, the map module 112 may associate the data elements based on conditions. For example, if temperature and pressure values come in from sensor 2, transmit the data elements 105 to analytic 2; and if only temperature values come in from sensor 2, transmit the data element 105 to analytic module 1.

In some embodiments, the map module 112 may further associate a data element 105 with a priority indicator 408. The priority indicator 408 may indicate the order in which two or more analytic modules 108 may receive the data element 105, when pushed by the distribution center module 106. In some embodiments, the priority indicator 408 may be associated with the data element 105 prior to, at the same time as, or at substantially the same time as, the date element 105 is associated with the analytic module 108.

Turning back to the process 200, in S218, subscribers 116 in the distribution center module 106 take the data element(s) 105 from the queue 114 and access the database 113 in the map module 112 using the name and attribute of the data element 105 to determine and retrieve the associated analytic module 108 and priority indicator 408. As used herein, the term “subscriber(s)” refers to worker module(s) or systems that take the data from the queue 114 and use the map module 112 to send the data to the corresponding analytic module 108. The subscriber(s) may listen to the queue 114 in order to know if any data is added, and processed accordingly.

In S220, the subscriber 116 calls the analytic module 108 with the highest priority indicator 408 and pushes the data element 105 to that analytic module 108. For example, if temperature values from sensor 2 come in, the value of the priority indicator 408 indicates the temperature value should be transmitted to analytic module 1 before being transmitted to analytic module 2. In some embodiments, the data element 105 is pushed to the analytic module after determining the appropriate analytic module 108 per the map module 112, instead of waiting for a request from the analytic module. Unlike conventional systems where the analytic module calls for the data, in one or more embodiments, the distribution center module 106 includes the calling mechanism, such that the data element 105 is pushed or transmitted to the appropriate analytic module 108 without the analytic module calling on a device to pull the data therefrom. As described above, a benefit of the distribution center module 106 pushing out the data is that the analytic modules do not have to poll for data (e.g., there is no delay in the execution of the analytics). Another benefit of the distribution center module 106 pushing out the data is that if the data arrives at irregular intervals, then this mechanism described in embodiments solves the problem of waiting for a certain time to retrieve the data by delivering the data to the analytic module 108 as soon the data arrives.

Then at S222, the first analytic module 108 analyzes (e.g., processes, linearizes, and derive a position (e.g., forecast) of) the data element 105, resulting in an analysis. In one or more embodiments, the analysis may be a forecast of energy production. For example, the analysis may be a prediction of the amount of energy produced by at least one wind turbine for the next day or for multiple days. Examples of methods of analyzing the data may include, for example, numerical calculations, numerical analysis, pattern recognition and modeling. Other suitable types of analyses may be used. In one or more embodiments, the analytic modules 108 may use external data (e.g., models 109 or historic data) to analyze the received data element(s) 105. For example, if the measurement is temperature, the analytic module 108 may compare the received temperature to a previous temperature or a threshold value to determine a forecast of energy production. In some embodiments, the analytic module 108 may transmit the analysis in 5224. In some embodiments, the analytic module 108 may transmit the analysis to the distribution center module 106. The subscriber 116 may put the analysis in the queue 114, where it may be transmitted to at least one of: another analytic module 108 for further analysis, based in part on a priority indicator 408; the asset 102 (via the collection device 103); and a decision module 110 for further analysis. In some embodiments, the decision module 110 may use the forecast to evaluate asset (e.g., wind turbine) performance, and/or optimize operation of the asset. For example, the operation of a turbine may be turned off if the market demands for power are low.

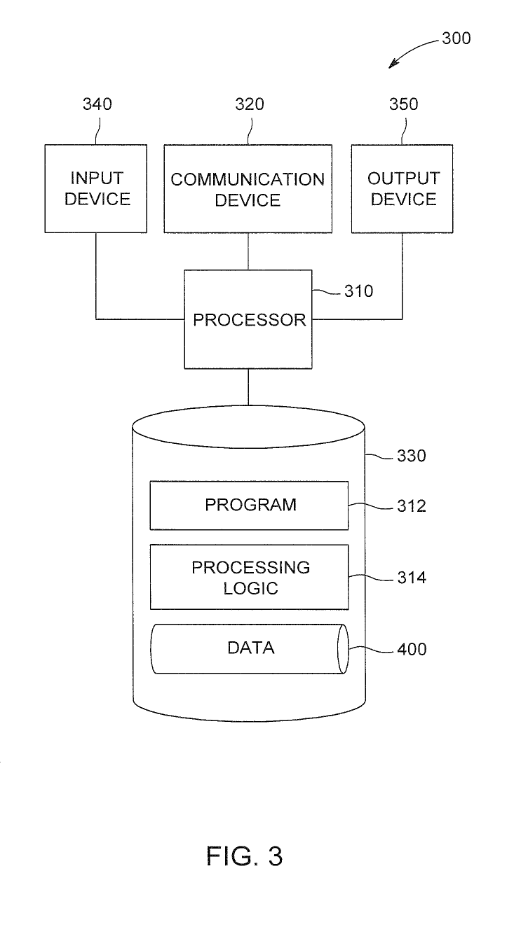

Note the embodiments described herein may be implemented using any number of different hardware configurations. For example, FIG. 3 illustrates a distribution center mapping platform 300 that may be, for example, associated with the system 100 of FIG. 1. The distribution center mapping platform 300 comprises a distribution center mapping processor 310 (“processor”), such as one or more commercially available Central Processing Units (CPUs) in the form of one-chip microprocessors, coupled to a communication device 320 configured to communicate via a communication network (not shown in FIG. 3). The communication device 320 may be used to communicate, for example, with one or more users. The distribution center mapping platform 300 further includes an input device 340 (e.g., a mouse and/or keyboard to enter information about the measurements and/or assets) and an output device 350 (e.g., to output and display the data and/or recommendations).

The processor 310 also communicates with a memory/storage device 330. The storage device 330 may comprise any appropriate information storage device, including combinations of magnetic storage devices (e.g., a hard disk drive), optical storage devices, mobile telephones, and/or semiconductor memory devices. The storage device 330 may store a program 312 and/or distribution center mapping processing logic 314 for controlling the processor 310. The processor 310 performs instructions of the programs 312, 314, and thereby operates in accordance with any of the embodiments described herein. For example, the processor 310 may receive data elements from the sensors and then may apply the data center module 106 via the instructions of the programs 312, 314 to map the data elements to the appropriate analytic module.

The programs 312, 314 may be stored in a compressed, uncompiled and/or encrypted format. The programs 312, 314 may furthermore include other program elements, such as an operating system, a database management system, and/or device drivers used by the processor 310 to interface with peripheral devices.

As used herein, information may be “received” by or “transmitted” to, for example: (i) the platform 300 from another device; or (ii) a software application or module within the platform 300 from another software application, module, or any other source.

In some embodiments (such as shown in FIG. 3), the storage device 330 further stores a map module database 400. Some examples of databases that may be used in connection with the distribution center mapping platform 300 will now be described in detail with respect to FIG. 4. Note that the database described herein is only an example, and additional and/or different information may actually be stored therein. Moreover, various databases might be split or combined in accordance with any of the embodiments described herein.

Referring to the map module database in FIG. 4, a table 400 is shown that represents the map module database 400 that may be stored in memory 330 (distribution center mapping platform 300) according to some embodiments. The table may include, for example, entries identifying data element information associated with analytic modules. The table 400 may define fields 402, 404, 406, and 408. The fields 402, 404, 406 and 408, may, according to some embodiments, specify: an analytic module 402, a name 404, an attribute 406 and a priority indicator 408 of the data element 105. Other suitable fields may be used in addition to, or instead of, the fields listed herein. The map module database 400 may be created and updated, for example, based on information electrically received on a periodic basis.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It should be noted that any of the methods described herein can include an additional step of providing a system comprising distinct software modules embodied on a computer readable storage medium; the modules can include, for example, any or all of the elements depicted in the block diagrams and/or described herein; by way of example and not limitation, a distribution center module. The method steps can then be carried out using the distinct software modules and/or sub-modules of the system, as described above, executing on one or more hardware processors 410 (FIG. 4). Further, a computer program product can include a computer-readable storage medium with code adapted to be implemented to carry out one or more method steps described herein, including the provision of the system with the distinct software modules.

This written description uses examples to disclose the invention, including the preferred embodiments, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims. Aspects from the various embodiments described, as well as other known equivalents for each such aspects, can be mixed and matched by one of ordinary skill in the art to construct additional embodiments and techniques in accordance with principles of this application.

Those in the art will appreciate that various adaptations and modifications of the above-described embodiments can be configured without departing from the scope and spirit of the claims. Therefore, it is to be understood that the claims may be practiced other than as specifically described herein.

1. A method comprising:
receiving, at a distribution center module, one or more data elements;
determining one or more analytic modules associated with the data element;
transmitting the one or more data elements to the one or more analytic modules based upon receipt at the distribution center module of the one or more data elements;
generating a forecast of energy production via the one or more analytic module; and
operating an asset based on the forecast of energy production.

2. The method of claim 1, further comprising:
providing one or more tags associated with the one or more data elements.

3. The method of claim 2, wherein the one or more tags include at least one of a name, a value and an attribute.

4. The method of claim 3, wherein determining one or more analytic modules associated with the data element is based on a mapping of the name and the attribute to the analytic module.

5. The method of claim 1, further comprising:
transmitting the one or more data elements to a first analytic module based on a priority indicator.

6. The method of claim 5, further comprising:
generating a first analysis at the first analytic module based on an analysis of the one or more transmitted data elements.

7. The method of claim 6, wherein the first analysis is a prediction of the amount of energy produced by at least one wind turbine.

8. The method of claim 6, further comprising:
transmitting the first analysis from the first analytic module to the distribution center module; and
transmitting the first analysis from the distribution center module to a second analytic module.

9. The method of claim 6, wherein the first analytic module has a higher priority indicator than the second analytic module.

10. The method of claim 1, further comprising:
generating one or more data elements via one or more sensors; and
collecting the generated one or more data elements at a collection device prior to receiving the one or more data elements at the distribution center module.

11. The method of claim 1, further comprising:
applying, via the one or more analytical modules, one or more models to the received one or more data elements.

12. A system comprising:
a distribution center module operative to receive one or more data elements;
one or more analytic modules operative to generate a forecast of energy production based on data elements received from the distribution center module;
a memory in communication with the distribution center module and storing program instructions, the distribution center module operative with the program instructions to perform the functions as follows:
determining one or more analytic modules associated with the one or more received data elements; and
transmitting the one or more data elements to the one or more analytic modules based upon receipt at the distribution center module of the one or more data elements;
one or more decision modules operative to receive the forecast and execute operation of an asset based on the forecast of energy production.

13. The system of claim 12, wherein one or more tags are associated with the one or more data elements.

14. The system of claim 13, wherein the one or more tags include at least one of a name, a value and an attribute.

15. The system of claim 14, wherein determining one or more analytic modules associated with the data element is based on a mapping of the name and the attribute to the analytic module.

16. The system of claim 12, wherein transmission of the one or more data elements to a first analytic module of the one or more analytic modules is based on a priority indicator.

17. The system of claim 16, wherein a first analysis is transmitted from the first analytic module to the distribution center module; and the first analysis is transmitted from the distribution center module to a second analytic module of the one or more analytic modules.

18. The system of claim 17, wherein the first analytic module has a higher priority indicator than the second analytic module.

19. The system of claim 12, further comprising:
one or more sensors operative to generate one or more data elements.

20. The system of claim 19, wherein the one or more sensors are associated with one or more wind turbines.

21. The system of claim 19, further comprising:
a collection device operative to collect the one or more generated data elements from the asset and transmit the collected one or more data elements to the distribution center module.
